(19) United States
(12) Patent Application Publication
(10) Pub. No.: US 2019/0013742 A1
(43) Pub. Date: Jan. 10, 2019

(54) VOLTAGE SOURCE CONVERTER

(71) Applicant: General Electric Technology GmbH, Baden (CH)

(72) Inventors: Pablo BRIFF, Stafford (GB); David Reginald TRAINER, Alvaston Derby (GB); Francisco Jose MORENO-MUNOZ, Stafford (GB); Francisco Javier CHIVITE-ZABALZA, Stafford (GB)

(21) Appl. No.: 15/748,719

(22) PCT Filed: Aug. 4, 2016
(86) PCT No.: PCT/EP2016/068663

§ 371 Date: Jan. 30, 2018

(30) Foreign Application Priority Data
Aug. 5, 2015 (GB) 1513857.1

(51) Int. Cl. H02M 7/483; H02M 7/797; H02J 3/36

(52) U.S. Cl. CPC H02M 7/483; H02M 2007/4835; H02J 3/36; H02M 7/797

(57) ABSTRACT

A voltage source converter includes DC terminals for connection to a DC network, a plurality of converter limbs between the DC terminals, and a controller. Each converter limb includes first and second limb portions separated by a respective AC terminal, the AC terminal of each converter limb connecting to a multi-phase AC network. Each limb portion extends between a corresponding DC terminal and AC terminal. Each limb portion including a valve having switching element(s) and energy storage device(s), the switching element being switchable to selectively insert the energy storage device into the limb portion and bypass the energy storage device to control a voltage across that valve. The controller is programmed to control the switching of valves to form a current circulation path including the limb portions corresponding to the selected valves, the AC phases connected to the limb portions corresponding to the selected valves, and the DC network.

### BACKGROUND OF THE INVENTION

This invention relates to a voltage source converter and to a method of operating a voltage source converter.

### BRIEF DESCRIPTION OF THE INVENTION

In power transmission networks alternating current (AC) power is converted to direct current (DC) power for transmission via overhead lines, under-sea cables, underground cables, and so on. This conversion to DC power removes the need to compensate for the AC capacitive load effects imposed by the power transmission medium, i.e. the transmission line or cable, and reduces the cost per kilometre of the lines and/or cables, and thus becomes cost-effective when power needs to be transmitted over a long distance.

A converter provides the required conversion between AC power and DC power within the network.

According to a first aspect of the invention, there is provided a voltage source converter including first and second DC terminals for connection to a DC network, a plurality of converter limbs, and a controller.

Each converter limb extends between the first and second DC terminals, and each converter limb including first and second limb portions separated by a respective AC terminal. The AC terminal of each converter limb for connection to a respective AC phase of a multi-phase AC network. Each first limb portion extends between the corresponding first DC terminal and AC terminal. Each second limb portion extends between the corresponding second DC terminal and AC terminal. Each limb portion includes a respective valve, each valve including at least one switching element and at least one energy storage device. The or each switching element of each valve being switchable to selectively insert the or each corresponding energy storage device into the corresponding limb portion and bypass the or each corresponding energy storage device in order to control a voltage across that valve.

The controller may be programmed to control the switching of a selected valve of one of the plurality of converter limbs and another selected valve of another of the plurality of converter limbs so as to form a current circulation path passing through the selected valves, the current circulation path including the limb portions corresponding to the selected valves, the AC phases connected to the limb portions corresponding to the selected valves, and the DC network.

The controller during formation of the current circulation path switches the selected valves to force a circulating alternating current to flow through the current circulation path, the circulating alternating current including at least one alternating current component, and the controller is programmed to control the switching of the selected valves to control the phase angle and amplitude of the or each alternating current component of the circulating alternating current to control the amount of energy transferred to or from the or each energy storage device of each selected valve resulting from the flow of the circulating alternating current through each selected valve.

Operation of the voltage source converter to transfer power between the DC and AC networks could result in energy accumulation in or energy loss from at least one energy storage device, thus resulting in deviation of the energy level of at least one energy storage device from a reference value.

Such a deviation is undesirable because, if too little energy is stored within a given energy storage device then the range of the voltage waveform the corresponding valve is able to generate is reduced, whereas if too much energy is stored in a given energy storage device then over-voltage problems may arise. The former would require the addition of a power source to restore the energy level of the affected energy storage device to the reference value, while the latter would require an increase in voltage rating of one or more energy storage devices to prevent the over-voltage problems, thus adding to the overall size, weight and cost of the voltage source converter. In addition if too little energy is stored within a given energy storage device then the voltage source converter might trip due to under-voltage protection.

The configuration of the voltage source converter of the invention enables the formation of the current circulation path and the provision of the circulating alternating current in order for energy to be selectively transferred to and from each selected valve to regulate its energy level, thereby obviating the problems associated with a deviation of the energy level of at least one energy storage device from the reference value.

The ability of the controller to control the phase angle and amplitude of the or each alternating current component of the circulating alternating current to control the amount of transferred energy not only allows the variation of the phase angle and amplitude of the or each alternating current component of the circulating alternating current to modify the amount of energy transferred to or from each selected valve resulting from the flow of the circulating alternating current through each selected valve, but also enables the configuration of the circulating alternating current to accommodate different energy regulation requirements of different selected valves. This can be particularly beneficial when the amount of energy required to be transferred to and from a given valve varies due to fluctuations in the energy level of the given selected valve during the operation of the voltage source converter.

In addition the ability of the controller to control the phase angle and amplitude of the or each alternating current component of the circulating alternating current to control the amount of transferred energy provides operational flexibility to meet different requirements of the voltage source converter during the regulation of the energy level of each selected valve. For example, the phase angle and amplitude of the or each alternating current component may be controlled to reduce any distortion of the DC and AC voltage waveforms at the DC and AC terminals or to control the rate at which energy is transferred to or from a given selected valve.

Shaping the current circulation path to pass through the selected valves belonging to different converter limbs permits ready formation of the current circulation path during the operation of the voltage source converter to transfer power between the DC and AC networks. This is because the control of the switching of the valves during the operation of the voltage source converter to transfer power between the DC and AC networks includes the formation of a current path passing through valves of different converter limbs and hence does not require any substantive redesign of the control of the switching of the valves to accommodate the formation of the current circulation path. For example, in a preferred embodiment of the invention, the selected valves may include: the valve of the first limb portion of one of the plurality of converter limbs; and the valve of the second limb portion of another of the plurality of converter limbs.

One way for regulating the energy levels of the valves is to simultaneously connect the first and second limb portions of the same converter limb into circuit for a finite overlap period to temporarily circulate a current through the valve of the first limb portion, the valve of the second limb portion and the DC network. This however requires the additional incorporation of the finite overlap period into the control of the switching of the valves during the operation of the voltage source converter to transfer power between the DC and AC networks, since the simultaneous connection of the first and second limb portions of the same converter limb into circuit is not required to effect the transfer of power between the DC and AC networks. The length of the overlap period is limited in order to minimise its effect on the converter ratings.

The use of the overlap period to regulate the energy levels of the energy storage devices of the valves not only results in some distortion of the DC and AC voltage waveforms at the DC and AC terminals due to the need to transfer the required energy in the limited overlap period when regulating the energy levels of the valves connected into circuit, but also delays the regulation of the energy levels of the other valves, since any given overlap period can be used to only regulate the energy levels of the valves that are connected into circuit. This in turn could cause a substantial ripple in the instantaneous energy levels of the energy storage devices and thereby result in a voltage ripple across the energy storage devices, with the potential risk of exceeding the operating voltage limit of at least one of the energy storage devices.

In contrast, the voltage source converter of the invention permits the transfer of energy to and from each selected valve to occur throughout the period during which the selected valve is connected into circuit, instead of just the overlap period. This increases the overall amount of time available to regulate the energy level of a given valve and thereby allows the transfer of energy to and from the given valve to be distributed over a longer period of time, thus reducing in less distortion of the DC and AC voltage waveforms at the DC and AC terminals. The voltage source converter of the invention also reduces the delay in regulating the energy levels of the other valves, since energy regulation can be carried out as soon as a given valve is connected into circuit through the formation of the current circulation path.

The characteristics of the circulating alternating current and the resulting energy transfer to and from each selected valve may vary depending on the requirements of the voltage source converter.

In embodiments of the invention, the circulating alternating current may include a fundamental frequency alternating current component and/or at least one non-fundamental frequency alternating current component. An example of a non-fundamental frequency alternating current component is a harmonic current component.

Controlling the amount of energy transferred to or from each selected valve resulting from the flow of the circulating alternating current through each selected valve may include increasing, decreasing or maintaining the energy level of each selected valve. The phase angle and amplitude of the or each alternating current component of the circulating alternating current may be controlled to provide a circulating alternating current that enables the increase, decrease or maintenance of the energy level of one of the selected valves and at the same time enables the increase, decrease or maintenance of the energy level of another of the selected valves. The phase angle and amplitude of the or each alternating current component of the circulating alternating current may be controlled such that the increase/decrease of the energy level of one of the selected valves is the same as or different from the increase/decrease of the energy level of another of the selected valves in terms of amount of energy. In this manner the phase angle and amplitude of the or each alternating current component of the circulating alternating current may be controlled to provide a circulating alternating current to meet different energy regulation requirements of different selected valves.

Controlling the amount of energy transferred to or from each selected valve resulting from the flow of the circulating alternating current through each selected valve may include controlling the energy level of each selected valve to move towards or reach a target energy level.

The formation of the current circulation path and the provision of the circulating alternating current provides a reliable means of controlling the energy level of a given valve to rapidly achieve a target energy level. This can be particularly when a power transmission network, in which the voltage source converter is incorporated, is recovering from a fault or is responding to the issuance of a power ramp command.

The target energy level of a given valve may be determined from a target energy level of the or each energy storage device of the given valve, which may be the average of the energy levels of a plurality of energy storage devices across the given valve, across the corresponding converter limb, across multiple converter limbs, or across the voltage source converter. The target energy level of a given energy storage device may be a portion of the maximum energy storage capacity of the given energy storage device.

In further embodiments of the invention, the controller is programmed to control the switching of the selected valves to shift the phase angle of and/or vary the amplitude of the or each alternating current component to modify the amount of energy transferred to or from each selected valve resulting from the flow of the circulating alternating current through each selected valve. This permits variation in the regulation of the energy level of each selected valve.

In still further embodiments of the invention, the controller may be programmed to control the switching of the valves to form a plurality of current circulation paths throughout an operating cycle of the voltage source converter, wherein the plurality of current circulation paths respectively passes through different sets of selected valves.

It will be understood that one set of selected valves is different from another set of selected valves when the one set of selected valves includes at least one valve that is not in the other set of selected valves, or when the one set of selected valves excludes at least one valve that is in the other set of selected valves.

The ability to form a plurality of current circulation paths not only permits the regulation of the energy levels of different sets of selected valves during an operating cycle of the voltage source converter, but also lengthens the time available for regulating the energy level of a given valve during an operating cycle of the voltage source converter.

The formation of the plurality of current circulation paths may be performed such that, at any given time during the operating cycle of the voltage source converter, energy regulation of the energy level of at least one of the valves is being carried out.

The controller may be programmed to control the switching of the valves during the formation of the current circulation path to selectively insert the or each corresponding energy storage device into the corresponding limb portion and bypass the or each corresponding energy storage device so as to control the configuration of an AC voltage waveform at the corresponding AC terminal to facilitate the transfer of power between the DC and AC networks. Programming the controller in this manner permits the regulation of the energy levels of the valves of the voltage source converter to be carried out simultaneously with the transfer of power between the DC and AC networks, thus resulting in an efficient operation of the voltage source converter.

The structure of each valve may vary, examples of which are described as follows.

Each valve may include a plurality of modules. Each module may include at least one switching element and at least one energy storage device. The or switching element and the or each energy storage device in each module may be arranged to be combinable to selectively provide a voltage source.

The plurality of modules may define a chain-link converter. The structure of the chain-link converter permits build-up of a combined voltage across the chain-link converter, which is higher than the voltage available from each of its individual modules, via the insertion of the energy storage devices of multiple modules, each providing its own voltage, into the chain-link converter. In this manner switching of the or each switching element in each module causes the chain-link converter to provide a stepped variable voltage source, which permits the generation of a voltage waveform across the chain-link converter using a step-wise approximation. As such the chain-link converter is capable of providing a wide range of complex voltage waveforms for controlling the phase angle and amplitude of the or each alternating current component of the circulating alternating current.

Optionally each limb portion may include a director switch connected in series with the corresponding valve between the respective DC and AC terminals, and the director switches of the first and second limb portions are switchable to switch the respective limb portions into and out of circuit between the respective DC and AC terminals. This in turn enables the switching of the respective valves into and out of circuit between the respective DC and AC terminals to aid the formation of the current circulation path.

At least one switching element may include at least one self-commutated switching device. The or each self-commutated switching device may be an insulated gate bipolar transistor, a gate turn-off thyristor, a field effect transistor, an injection-enhanced gate transistor, an integrated gate commutated thyristor or any other self-commutated switching device. The number of switching devices in each switching element may vary depending on the required voltage and current ratings of that switching element.

The or each switching element may further include a passive current check element that is connected in anti-parallel with the or each switching device.

The or each passive current check element may include at least one passive current check device. The or each passive current check device may be any device that is capable of limiting current flow in only one direction, e.g. a diode. The number of passive current check devices in each passive current check element may vary depending on the required voltage and current ratings of that passive current check element.

Each energy storage device may be any device that is capable of storing and releasing energy, e.g. a capacitor, fuel cell or battery.

According to a second aspect of the invention, there is provided a method of operating a voltage source converter, the voltage source converter including first and second DC terminals for connection to a DC network, and a plurality of converter limbs. Each converter limb extends between the first and second DC terminals, each converter limb including first and second limb portions separated by a respective AC terminal. The AC terminal of each converter limb connecting to a respective AC phase of a multi-phase AC network. Each first limb portion extends between the corresponding first DC terminal and AC terminal, and each second limb portion extends between the corresponding second DC terminal and AC terminal. Each limb portion includes a respective valve, each valve including at least one switching element and at least one energy storage device. The or each switching element of each valve being switchable to selectively insert the or each corresponding energy storage device into the corresponding limb portion and bypass the or each corresponding energy storage device in order to control a voltage across that valve.

The method includes switching a selected valve of one of the plurality of converter limbs and another selected valve of another of the plurality of converter limbs so as to form a current circulation path passing through the selected valves, the current circulation path including the limb portions corresponding to the selected valves, the AC phases connected to the limb portions corresponding to the selected valves, and the DC network. The method further includes during formation of the current circulation path, switching the selected valves to force a circulating alternating current to flow through the current circulation path, the circulating alternating current including at least one alternating current component. The method further including switching the selected valves to control the phase angle and amplitude of the or each alternating current component of the circulating alternating current to control the amount of energy transferred to or from each selected valve resulting from the flow of the circulating alternating current through each selected valve.

The features and advantages of the voltage source converter of the first aspect of the invention and its embodiments apply mutatis mutandis to the method of the second aspect of the invention.

It will also be appreciated that the use of the terms “first” and “second” in the patent specification is merely intended to help distinguish between similar features (e.g. the first and second limb portions), and is not intended to indicate the relative importance of one feature over another feature.

### BRIEF DESCRIPTION OF THE DRAWINGS

A preferred embodiment of the invention will now be described, by way of a non-limiting example, with reference to the accompanying drawings in which:

FIG. 1 shows schematically a voltage source converter according to an embodiment of the invention;

FIG. 2a shows schematically the structure of a full-bridge module;

FIG. 2b shows schematically the structure of a half-bridge module;

FIG. 3 shows schematically the operation of the voltage source converter of FIG. 1 to regulate the energy levels of its valves;

FIG. 4 shows schematically an equivalent model of a converter limb of the voltage source converter of FIG. 1 from an energy perspective;

FIG. 5 illustrates graphically the regions in the complex z-plane in which the energy level of a selected valve of the voltage source converter of FIG. 1 when in a cross-overlap mode increases, decreases or stays the same;

FIG. 6 illustrates graphically the regions in the complex z-plane in which the energy level of another selected valve of the voltage source converter of FIG. 1 when in a cross-overlap mode increases, decreases or stays the same;

FIG. 7 illustrates graphically an intersection between the regions illustrated in FIGS. 5 and 6;

FIG. 8 illustrates graphically a specific form of the intersection between the regions illustrated in FIGS. 5 and 6 for a specific operating point of the voltage source converter of FIG. 1;

FIG. 9 illustrates graphically an intersection of regions in a transformed v-plane resulting from a conformal transformation of the regions illustrated in FIGS. 5 and 6;

FIGS. 10 to 12 illustrates graphically different energy regulation scenarios involving different energy requirements of the valves of the voltage source converter of FIG. 1; and

FIGS. 13 to 15 illustrate graphically the results of a simulation of the operation of the voltage source converter of FIG. 1 to regulate the energy levels of its valves.

### DETAILED DESCRIPTION OF THE INVENTION

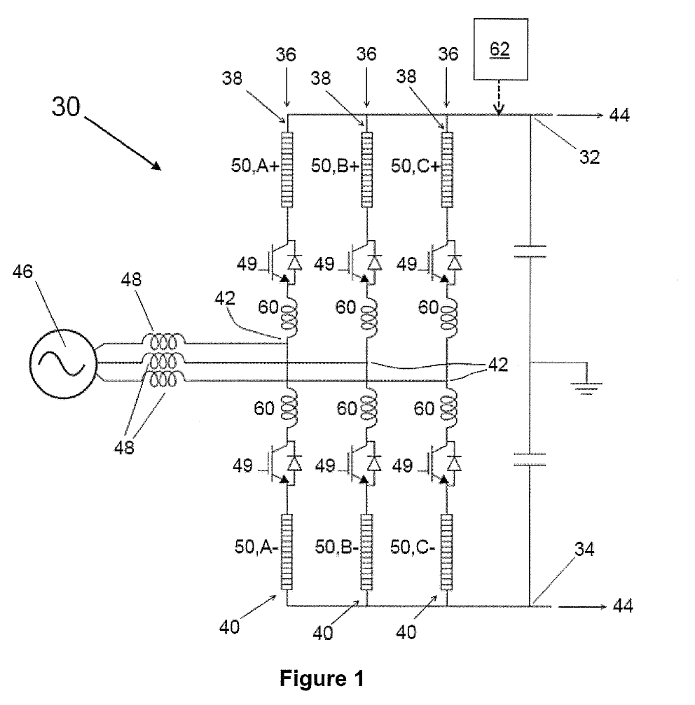

A voltage source converter according to an embodiment of the invention is shown in FIG. 1 and is designated generally by the reference numeral 30.

The voltage source converter 30 includes first and second DC terminals 32,34 and a plurality of converter limbs 36. Each converter limb 36 extends between the first and second DC terminals 32,34 and includes first and second limb portions 38,40 separated by a respective AC terminal 42. In each converter limb, the first limb portion extends between the first DC terminal 32 and the AC terminal 42, while the second limb portion extends between the second DC terminal 34 and the AC terminal 42.

In use, the first and second DC terminals 32,34 of the voltage source converter 30 are respectively connected to first and second terminals of a DC network 44, and the AC terminal 42 of each converter limb 36 is connected to a respective AC phase of a three-phase AC network 46 via a respective series-connected phase inductor or transformer 48.

Each of the first and second limb portions 38,40 includes a director switch 49 connected in series with a valve 50.

Each director switch 49 includes a plurality of series-connected switching elements. It is envisaged that, in other embodiments of the invention, each plurality of series-connected switching elements may be replaced by a single switching element.

The configuration of the limb portions 38,40 in this manner means that, in use, the director switch 49 of each limb portion 38,40 is switchable to switch the respective limb portion 38,40 and therefore the respective valve 50 into and out of circuit between the respective DC and AC terminals 32,34,42.

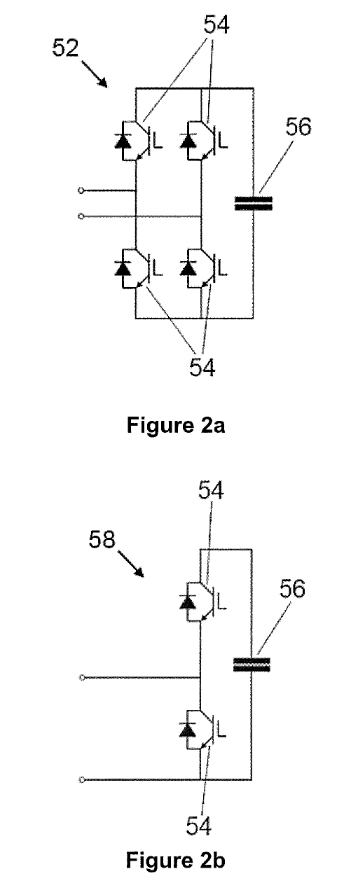

Each valve 50 includes a chain-link converter that is defined by a plurality of series-connected modules 52. FIG. 2a shows schematically the structure of each module 52.

Each module 52 includes two pairs of switching elements 54 and a capacitor 56 in a full-bridge arrangement. The two pairs of switching elements 54 are connected in parallel with the capacitor 56 in a full-bridge arrangement to define a 4-quadrant bipolar module that can provide negative, zero or positive voltage and can conduct current in both directions.

Each switching element 54 is in the form of an insulated gate bipolar transistor (IGBT) which is connected in parallel with an anti-parallel diode.

It is envisaged that, in other embodiments of the invention, each IGBT may be replaced by a gate turn-off thyristor, a field effect transistor, an injection-enhanced gate transistor, an integrated gate commutated thyristor or any other self-commutated semiconductor device. It is also envisaged that, in other embodiments of the invention, each diode may be replaced by a plurality of series-connected diodes.

The capacitor 56 of each module 52 is selectively bypassed or inserted into the corresponding chain-link converter by changing the states of the switching elements 54. This selectively directs current through the capacitor 56 or causes current 58 to bypass the capacitor 56, so that the module 52 provides a negative, zero or positive voltage.

The capacitor 56 of the module 52 is bypassed when the switching elements 54 in the module 52 are configured to form a short circuit in the module 52, whereby the short circuit bypasses the capacitor 56. This causes current in the corresponding chain-link converter to pass through the short circuit and bypass the capacitor 56, and so the module 52 provides a zero voltage, i.e. the module 52 is configured in a bypassed mode.

The capacitor 56 of the module 52 is inserted into the corresponding chain-link converter when the switching elements 54 in the module 52 are configured to allow the current in the corresponding chain-link converter to flow into and out of the capacitor 56. The capacitor 56 then charges or discharges its stored energy so as to provide a non-zero voltage, i.e. the module 52 is configured in a non-bypassed mode. The full-bridge arrangement of the module 52 permits configuration of the switching elements 54 in the module 52 to cause current to flow into and out of the capacitor 56 in either direction, and so the module 52 can be configured to provide a negative or positive voltage in the non-bypassed mode.

It is possible to build up a combined voltage across each chain-link converter, which is higher than the voltage available from each of its individual modules 52, via the insertion of the capacitors 56 of multiple modules 52, each providing its own voltage, into each chain-link converter. In this manner switching of the switching elements 54 in each module 52 causes each chain-link converter to provide a stepped variable voltage source, which permits the generation of a voltage waveform across each chain-link converter using a step-wise approximation.

It is envisaged that, in other embodiments of the invention, each module 52 may be replaced by another type of module, which includes at least one switching element and at least one energy storage device, the or switching element and the or each energy storage device in each module being arranged to be combinable to selectively provide a voltage source. For example, each module 52 may be replaced by a module 58 that includes a pair of switching elements 54 connected in parallel with a capacitor 56 in a half-bridge arrangement to define a 2-quadrant unipolar module that can provide zero or positive voltage and can conduct current in both directions, as shown in FIG. 2b.

It is also envisaged that, in other embodiments of the invention, the capacitor 56 in each module 52,58 may be replaced by another type of energy storage device which is capable of storing and releasing energy, e.g. a battery or a fuel cell.

Each limb portion 38,40 further includes an inductor 60 connected in series with the corresponding director switch 49 and valve 50.

The voltage source converter 30 further includes a controller 62 to control the switching of the switching elements 54 in the director switches 49 and the valves 50 in the limb portions 38,40.

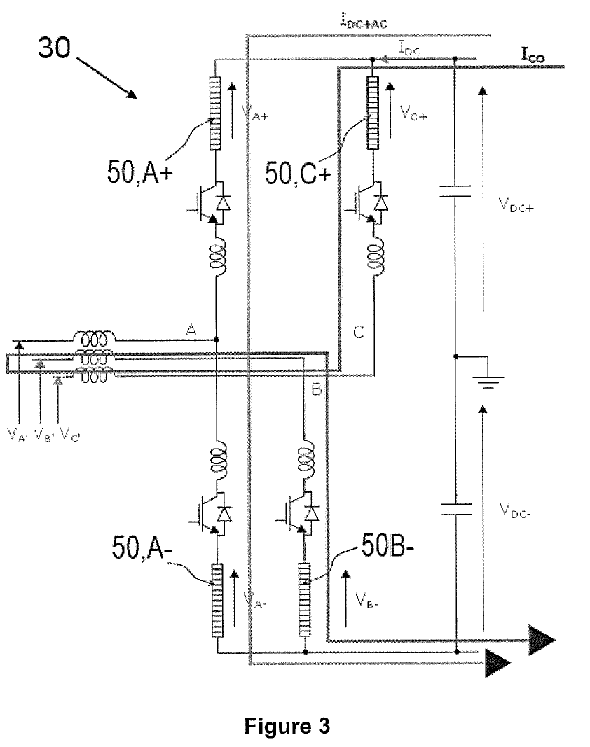

Operation of the voltage source converter 30 of FIG. 1 is described as follows, with reference to FIGS. 3 to 15.

In order to transfer power between the DC and AC networks 44,46, the controller 62 controls the director switches 49 to switch the respective valves 50 into and out of circuit between the respective DC and AC terminals 32,34,42 to interconnect the DC and AC networks 44,46. When a given valve 50 is switched into circuit between the respective DC and AC terminals 32,34,42, the controller 62 switches the switching elements 54 of the modules 52 of the given valve 50 to provide a stepped variable voltage source and thereby generate a voltage waveform so as to control the configuration of an AC voltage waveform at the corresponding AC terminal 42 to facilitate the transfer of power between the DC and AC networks 44,46.

To generate a positive AC voltage component of an AC voltage waveform at the AC terminal 42 of a given converter limb 36, the director switch 49 of the first limb portion 38 is closed (to switch the valve 50 connected in series therewith into circuit between the first DC terminal 32 and the corresponding AC terminal 42) and the director switch 49 of the second limb portion 40 is opened (to switch the valve 50 connected in series therewith out of circuit between the second DC terminal 34 and the corresponding AC terminal 42).

To generate a negative AC voltage component of an AC voltage waveform at the AC terminal 42 of a given converter limb 36, the director switch 49 of the second limb portion 40 is closed (to switch the valve 50 connected in series therewith into circuit between the second DC terminal 34 and the corresponding AC terminal 42) and the director switch 49 of the first limb portion 38 is opened (to switch the valve 49 connected in series therewith out of circuit between the first DC terminal 32 and the corresponding AC terminal 42).

The AC voltage waveform at each AC terminal 42 is phase-shifted from the AC voltage waveform at each other AC terminal 42 by 120 electrical degrees, as is typical practice for a voltage source converter 30 connected to a three-phase AC network 46.

During a changeover from a positive AC voltage component to a negative AC voltage component, the controller 62 switches the director switches 49 to switch both limb portions 38,40 of the same converter limb 36 concurrently into circuit during an overlap period of the operating cycle of the voltage source converter 30, i.e. valves A+ and A− are in “overlap mode”, so as to form a current path which includes each limb portion 38,40 and the DC network 44, as shown schematically in FIG. 3. Similarly, during a changeover from a negative AC voltage component to a positive AC voltage component, the controller 62 switches the director switches 49 to switch both limb portions 38,40 of the same converter limb 36 concurrently into circuit during another overlap period of the operating cycle of the voltage source converter 30, so as to form the same current path. This permits the temporary circulation of an overlap current I_{DC+AC} through the valve 50 of the first limb portion 38, the valve 50 of the second limb portion 40 and the DC network 44 in order to regulate the energy levels of the valves 50 of the limb portions 38,40 switched concurrently into circuit.

The use of the “overlap mode” applies mutatis mutandis to the valves B+,B−,C+,C− of each converter limb 36, instead of just the valves A+,A−.

The length of a given overlap period is limited to a maximum of 60 electrical degrees in order to minimise its impact of the converter ratings. Consequently there is a need to transfer the required energy in a limited amount of time in order to regulate the energy levels of the valves A+,A− of the limb portions 38,40 switched concurrently into circuit. The discontinuous nature of the energy regulation based on the use of the overlap period can result in some distortion of the DC and AC voltage waveforms V_{DC+},V_{DC-},V_{A′},V_{B′},V_{C′} at the DC and AC terminals 32,34,42.

Also the use of the overlap period for energy regulation purposes delays the regulation of the energy levels of the other valves B+,B−,C+,C− not switched into circuit, since any given overlap period can be used to only regulate the energy levels of the valves A+,A− of the limb portions 38,40 switched concurrently into circuit.

The use of the overlap period for energy regulation purposes therefore could cause a substantial ripple in the instantaneous energy levels of the capacitors 56 and thereby result in a voltage ripple across the capacitors 56, with the potential risk of exceeding the operating voltage limit of at least one of the capacitors 56.

A method of operating the voltage source converter 30 to regulate the energy levels of the valves 50 is described as follows.

Referring to FIG. 3, when the valves A+, A− of the limb portions 38,40 of a first of the converter limbs 36 are in the “overlap mode”, the valve B− of the second limb portion 40 of a second of the converter limbs 36 and the valve C+ of the first limb portion 38 of a third of the converter limbs 36 are switched into circuit between their respective DC and AC terminals 32,34,42 as part of the operation of the voltage source converter 30 to transfer power between the DC network 44 and the three-phase AC network 46. Meanwhile the valve B+ of the first limb portion 38 of the second converter limb 36 and the valve C− of the second limb portion 40 of the third converter limb 36 are switched out of circuit.

In this manner the controller 62 controls the switching of: a selected valve B− of one of the plurality of converter limbs 36; and another selected valve C+ of another of the plurality of converter limbs 36 so as to form a current circulation path passing through the selected valves B−,C+, where the current circulation path includes: the limb portions 38,40 corresponding to the selected valves B−,C+, the AC phases B,C connected to the limb portions 38,40 corresponding to the selected valves B−,C+; and the DC network 44. For the sake of simplicity, the selected valves B−,C+ are referred to as being in a “cross-overlap mode” during the formation of the current circulation path.

The “cross-overlap mode” applies mutatis mutandis to a selected valve 50 of any one of the plurality of converter limbs 36; and another selected valve 50 of any other of the plurality of converter limbs 36, instead of just the valves B−,C+.

During the “overlap mode” of the valves A+,A−, the AC voltage component of the voltage waveform generated by the selected valve C+ has a shape that is a function of (−cos(ωt)) since it is in anti-phase with the AC voltage component of the voltage waveform generated by the valve C−, where the latter is in phase with the AC phase C connected to the AC terminal 42 of the third converter limb 36. Meanwhile the AC voltage component of the voltage waveform generated by the selected valve B− has a shape that is a function of (−sin(ωt+π/6)) since it is in anti-phase with the AC voltage component of the voltage waveform generated by the valve B+. In both cases, it is assumed that t=0 at the start of the overlap period.

At this stage, i.e. during formation of the current circulation path, the controller 62 switches the selected valves B−,C+ to force a circulating alternating current I_{CO} to flow through the current circulation path. The circulating alternating current is configured to include a fundamental frequency alternating current component.

The circulating alternating current I_{CO} is given by:

I_{CO}=Î_{CO} cos(ωt+ϕ),

where ϕ is an angle measured from the cos(ωt) axis and increases in the anticlockwise direction in the z-plane.

By controlling the switching of the selected valves B−,C+ to control the phase angle and amplitude of the fundamental frequency alternating current component of the circulating alternating current I_{CO}, it is possible to control the amount of energy transferred to or from each selected valve B−,C+ resulting from the flow of the circulating alternating current through each selected valve B−,C+.

The control of the phase angle and amplitude of the fundamental frequency alternating current component of the circulating alternating current I_{CO} is based on the use of orthogonal signals during the overlap period [0,π/3], where t=0 is set at the start of the overlap period. In the field of power electronics, a voltage waveform and a current waveform are said to be orthogonal during a period of time if they do not exchange net active power in a given specified period. It will be understood that, for the purposes of this specification, orthogonality is intended to refer to electrical orthogonality but does not necessarily imply geometric orthogonality, since signals that are defined to be electrically orthogonal may not be π/2 degrees apart when drawn in a phasor diagram.

Let ƒ(t), g(t) be real-valued periodic functions with a period of 2π, i.e.:

ƒ(t)=ƒ(t+2π)

g(t)=g(t+2π)

The inner product of functions ƒ(t) and g(t), denoted as <ƒ,g>, is defined as:

<ƒ,g>=∫₀^{π/3}ƒ(t)g(t)dt

The real-valued periodic functions are said to be orthogonal if and only if <ƒ,g>=0. In the context of a power system, if the function ƒ(t) represents the voltage of a selected valve B−,C+ and the function g(t) represents the current flowing through the same selected valve B−,C+, the voltage and current waveforms are orthogonal provided that they will not exchange net active power during the overlap period. Hence, there will be no change in the average energy level of the selected valve B−,C+ due to the flow of the current waveform represented by the function g(t) by the end of the cycle. During the operating cycle there will be regions in which <ƒ,g> is positive, which indicates a transfer of energy to the selected valve B−,C+ so as to increase the energy level of the selected valve B−,C+. Conversely, during the operating cycle the regions in which <ƒ,g> is negative represent a transfer of energy from the selected valve B−,C+, which leads to a decrease in the energy level of the selected valve B−,C+.

During the formation of the current circulation path, the selected valves B−,C+ are connected in series and hence are affected by the same circulating alternating current I_{CO}. Since the selected valves B−,C+ may have different energy regulation requirements, it is desirable to choose a value of the phase angle of the fundamental frequency alternating current component of the circulating alternating current I_{CO} that accommodates the energy regulation requirements of both selected valves B−,C+. For example, if the energy level of the selected valve C+ was below its target energy level and the energy level of the selected valve B− was above its target energy level, the circulating alternating current I_{CO} would be configured such that it increased the energy level of the selected valve C+ while it decreased the energy level of the selected valve B−.

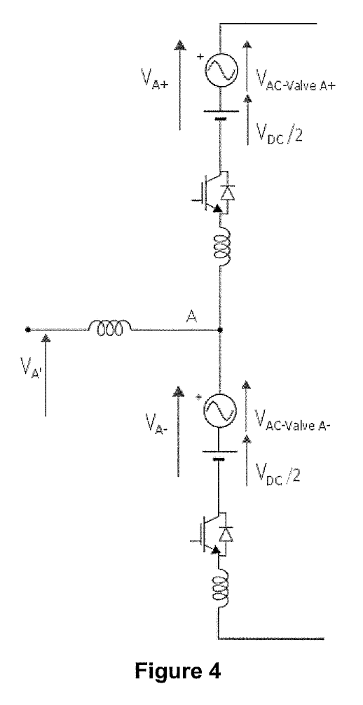

FIG. 4 shows schematically an equivalent model of a converter limb 36 from an energy perspective. In FIG. 4, it can be seen that the valve A+,A− in each limb portion 38,40 may be represented as a DC voltage source in series with an AC voltage source such that the voltage V_{A+},V_{A-} of each valve A+,A− is the sum of a DC voltage component V_{DC}/2 and an AC voltage component V_{AC-Valve A+},V_{AC-Valve A-}.

It is assumed that the voltage drops across the inductors 60 of the limb portions 38,40 are negligible in comparison to the voltages V_{A+},V_{A-},V_{B-},V_{C+} generated by the valves 50 and the AC voltage waveforms V_{A′},V_{B′},V_{C′} at the AC terminals 42, thus resulting in a negligible phase shift between the voltages V_{A+},V_{A-},V_{B-},V_{C+} generated by the valves 50 and the AC voltage waveforms V_{A′},V_{B′},V_{C′} at the AC terminals 42. From an energy regulation perspective, it can be assumed that the voltage V_{A-},V_{B-}, generated by the valve 50 of each second limb portion 40 is in phase with the AC voltage waveform V_{A′},V_{B′},V_{C′} at the corresponding AC terminal 42.

For the purpose of illustrating the working of the invention, the operation point of the voltage source converter 30 is exemplarily defined as:

$${\hat{V}}_{AC} = \frac{2}{3} {V}_{DC}$$

When the AC terminals 42 are connected respective to a plurality of secondary windings of a delta transformer (not shown), the AC phase voltage V_{A′},V_{B′},V_{C′} is equal to the AC line voltage. Therefore, the ratio between the DC voltage component and the AC voltage component of each valve 50 is defined as follows:

$$\frac{{\hat{V}}_{AC - Value}}{{V}_{DC - Value}} = \frac{( 2 / 3 ) {V}_{DC}}{( 1 / 2 ) {V}_{DC}} = \frac{4}{3}$$

For the above exemplary operating point of the voltage source converter 30, the following equations apply:

$$g ( t ) = {V}_{DC} ( 1 - \frac{4}{3} sin ( ω t + π / 6 ) )$$

$$f ( t ) = {V}_{DC} ( 1 - \frac{4}{3} cos ( ω t ) )$$

$$r ( t , {θ}_{1} ) = sin ( ω t + {θ}_{1} )$$

$$s ( t , {θ}_{2} ) = sin ( ω t + {θ}_{2} )$$

where g(t) and s(t,θ₂) represent the voltage and current waveforms, respectively, across the selected valve B−, and where ƒ(t) and r(t,θ₁) represent the voltage and current waveforms, respectively, across the selected valve C+.

In order to determine the point at which the voltage and current waveforms are orthogonal for each selected valve B−,C+, the values of θ₁ and θ₂ are determined as follows:

$$A {=}^{Δ} 〈 g , s 〉 = {V}_{DC} {\int }_{0}^{π / 6} ( 1 - \frac{4}{3} sin ( ω t + π / 6 ) ) sin ( ω t + {θ}_{2} ) dt = 0$$

$$B {=}^{Δ} 〈 f , r 〉 = {V}_{DC} {\int }_{0}^{π / 6} ( 1 - \frac{4}{3} cos ( ω t ) ) sin ( ω t + {θ}_{1} ) dt = 0.$$

Each of θ₁ and θ₂ is measured from the sin(ωt) axis and positively increases in the clockwise direction in the z-plane.

By numerically solving the above equations for the above exemplary operating point of the voltage source converter 30, it is found that θ₁=π+nπ and θ₂=2π/3+nπ, for some integer n E Z. It will be understood that the values of θ₁ and θ₂ depend on the operating point of the voltage source converter 30, which may vary depending on the requirements of the voltage source converter 30.

The determination of the values of θ₁ and θ₂ enables the determination of each region in the complex z-plane in which the energy level of each selected valve B−,C+ in the “cross-overlap mode” increases, decreases or stays the same.

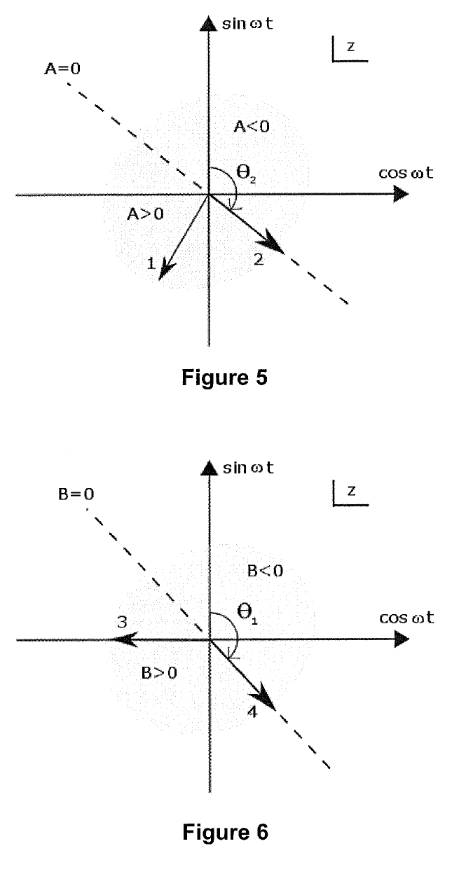

FIG. 5 illustrates graphically the regions in the complex z-plane in which the energy level of the selected valve B− in the “cross-overlap mode” increases (A>0), decreases (A<0) or stays the same (A=0). In FIG. 5, g(t) is labelled as 1, and s(t,θ₂) is labelled as 2.

FIG. 6 illustrates graphically the regions in the complex z-plane in which the energy level of the selected valve C+ in the “cross-overlap mode” increases (B>0), decreases (B<0) or stays the same (B=0). In FIG. 6, ƒ(t) is labelled as 3, and r(t,θ₁) is labelled as 4.

As mentioned above, since the selected valves B−,C+ in the “cross-overlap mode” are in series during the formation of the current circulation path, the same circulating alternating current I_{CO} flows through both selected valves B−,C+.

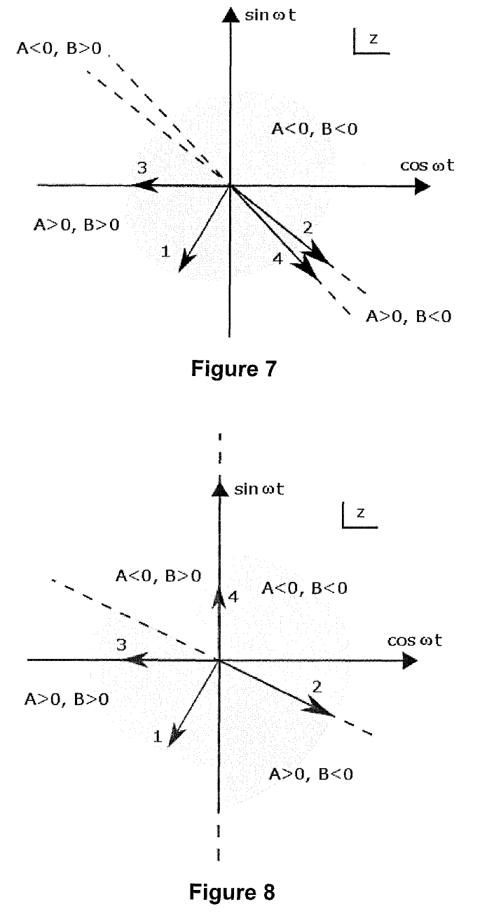

FIG. 7 illustrates graphically an intersection between the regions illustrated in FIGS. 5 and 6. The intersection in FIG. 7 determines the value of the phase angle that should be used for the fundamental frequency alternating current component of the circulating alternating current I_{CO} depending on the energy requirement of each selected valve B−,C+, which is to increase, decrease or maintain the energy level of that selected valve B−,C+.

The region indicated by A<0 and B<0 represents the range of the value of the phase angle that should be used for the fundamental frequency alternating current component of the circulating alternating current I_{CO} to decrease the energy levels of both selected valves B−,C+.

The region indicated by A<0 and B>0 represents the range of the value of the phase angle that should be used for the fundamental frequency alternating current component of the circulating alternating current I_{CO} to decrease the energy level of the selected valve B− and increase the energy level of the selected valve C+.

The region indicated by A>0 and B>0 represents the range of the value of the phase angle that should be used for the fundamental frequency alternating current component of the circulating alternating current I_{CO} to increase the energy levels of both selected valves B−,C+.

The region indicated by A>0 and B<0 represents the range of the value of the phase angle that should be used for the fundamental frequency alternating current component of the circulating alternating current I_{CO} to increase the energy level of the selected valve B− and decrease the energy level of the selected valve C+.

For the particular case of the above exemplary operating point of the voltage source converter 30, the intersecting regions illustrated in FIG. 7 take the specific form depicted in FIG. 8 in which it can be seen that the orthogonal phasors are geometrically orthogonal during the period of the “cross-overlap mode”.

For the sake of illustrating the general principle of the invention, the following description of the configuration of the circulating alternating current I_{CO} is based on the generic case depicted in FIG. 7.

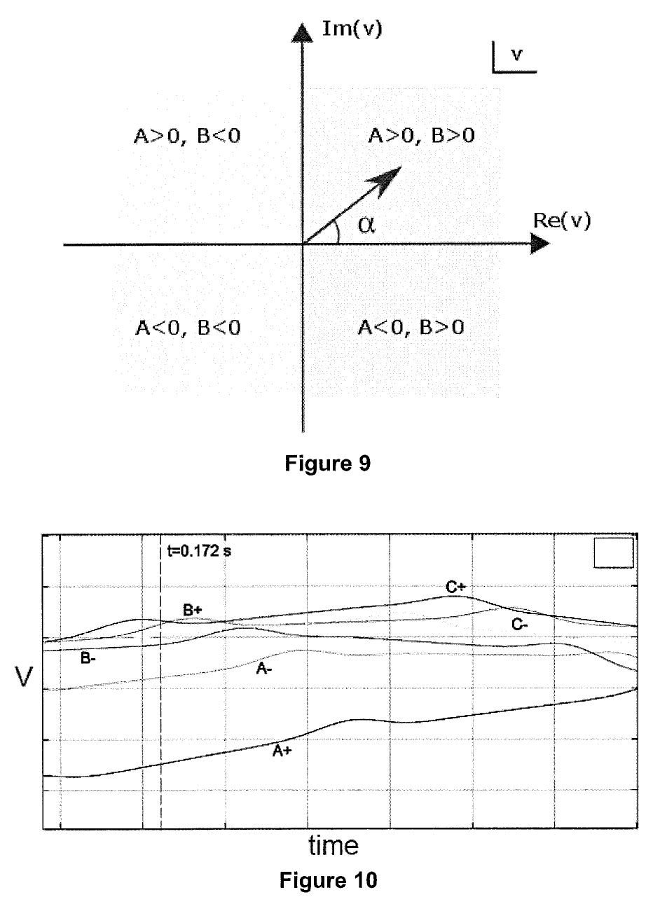

FIG. 9 illustrates graphically an intersection of regions in a transformed v-plane resulting from a conformal transformation of the regions illustrated in FIGS. 5 and 6.

The conformal transformation includes the transformation of the regions illustrated in FIG. 5, i.e. the cosine wave component, with the following conformal mapping:

T₁(z)=v₁=ze^{jθ}^{₁}

The conformal transformation also includes the transformation of the regions illustrated in FIG. 6, i.e. the sine wave component, with the following conformal mapping:

$${T}_{2} ( z ) = {v}_{2} = z {e}^{j ( {θ}_{2} + \frac{π}{2} )}$$

The angle α in the v-plane regulates the phase angle of the circulating alternating current I_{CO}, which defines the amount of energy transferred to or from each selected valve B−,C+. The angle α is defined as:

$$α {=}^{Δ} atan \frac{Δ {E}_{sin}}{Δ {E}_{cos}}$$

where ΔEₛᵢₙ is the energy deviation of the selected valve B− from its target energy level, and where ΔE_{cos} is the energy deviation of the selected valve C+ from its target energy level. This ensures that the angle α in the v-plane is regulated as a function of the ratio of energy deviations for the selected valves B−,C+ in the “cross-overlap mode”.

The orthogonal projections of the converted phasors onto the v-plane axes determine the transformed phasors in the original z-plane, by computing the transform inverse for each of the axes projections, namely:

Φₛᵢₙ=sg(ΔEₛᵢₙ)sin α

Φ_{cos}=sg(ΔE_{cos})cos α

where sg(x) is the sign function defined as

$$sg ( x ) {=}^{Δ} \frac{x}{\vert x \vert} .$$

it will be noted that sg(0) [symbol] 0.

The inverse conformal transforms are given by:

$${T}_{1}^{- 1} ( v ) = v {e}^{- j {θ}_{1}}$$

$${T}_{2}^{- 1} ( v ) = v {e}^{- j ( {θ}_{2} + \frac{π}{2} )}$$

The amplitude of the phasor in the transformed v-plane is given by:

Î_{CO}=K_{CO}(|ΔEₛᵢₙ|+|ΔE_{cos}|)

where K_{CO} is a scaling factor. The magnitude of the transformed phasor coincides with the amplitude of the circulating alternating current I_{CO} since the conformal transform does not change the magnitudes of the phasors in the z-plane, but only rotates them.

The phase angle of the fundamental frequency alternating current component of the circulating alternating current I_{CO} that satisfies the energy requirements of both selected valves B−,C+ in the “cross-overlap mode” is given by:

ϕ=|T₁⁻¹(Φₛᵢₙ)|arg[T₂⁻¹(Φ_{cos})]+|T₂⁻¹(Φ_{cos})|arg[T₁⁻¹(Φₛᵢₙ)]

This equation sets the phase angle of the fundamental frequency alternating current component of the circulating alternating current I_{CO} according to the energy requirements of each selected valve B−,C+ in the “cross-overlap” mode. The phase angle and amplitude of the fundamental frequency alternating current component of the circulating alternating current I_{CO} may be controlled in this manner to provide a circulating alternating current I_{CO} that enables the increase, decrease or maintenance of the energy level of one selected valve B− and at the same time enables the increase, decrease or maintenance of the energy level of the other selected valve C+. The phase angle and amplitude of the fundamental frequency alternating current component of the circulating alternating current I_{CO} may be controlled such that the increase/decrease of the energy level of one of the selected valves B− is the same as or different from the increase/decrease of the energy level of another of the selected valves C+ in terms of amount of energy.

For example, if the energy level of the selected valve C+ is at or near its target energy level and therefore does not require any incoming or outgoing transfer of energy as a result of the flow of the circulating alternating current I_{CO} therethrough, then |T₂⁻¹(Φ_{cos})|=0 and the inverse transform locates the current phase on the angle arg[T₁⁻¹(Φₛᵢₙ)] which coincides with the angle orthogonal to −cos(ωt) during the overlap period. In this manner the circulating alternating current I_{CO} is configured such that only the selected valve B− experiences a change in its energy level due to an incoming or outgoing transfer of energy as a result of the flow of the circulating alternating current I_{CO} therethrough.

FIGS. 10 to 12 illustrates graphically different energy regulation scenarios involving different energy requirements of the valves 50 of the voltage source converter 30.

In FIG. 10, the average capacitor voltages of the valves 50 are scaled to their respective target voltage levels such that the average capacitor voltage of each valve 50 is at its target voltage level when the respective graph curve is on the ordinate y=1.

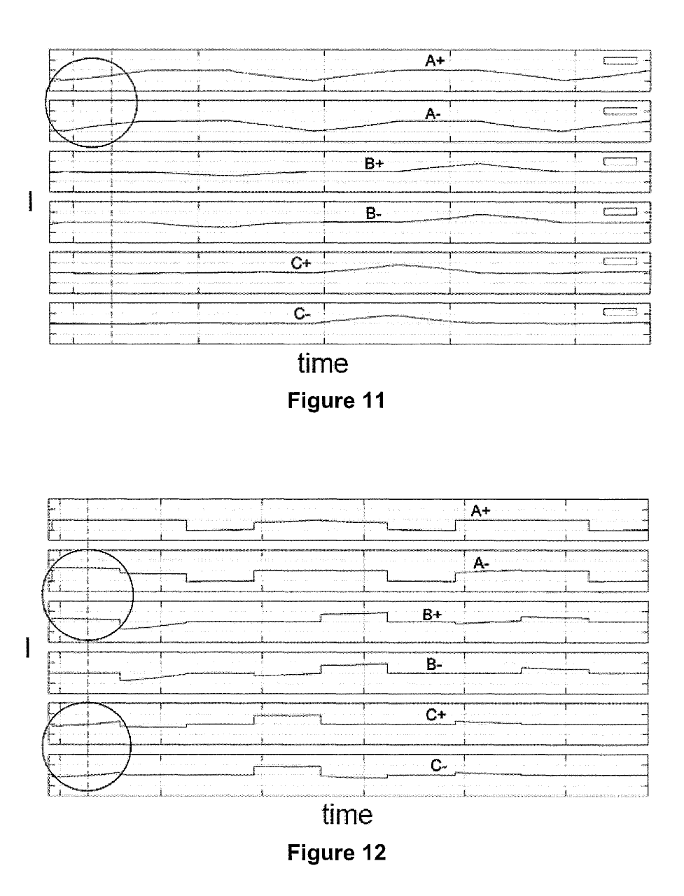

It can be observed in FIG. 10 that, at time t=0.172 sec (marked as a dashed vertical line) the average capacitor voltages of the pair of valves A+, A− are far below their respective target voltage levels (since valve A+ is significantly far from the target), i.e. the energy levels of the pair of valves A+, A− are far below their respective target energy levels, and so it is necessary to transfer energy into the pair of valves, A+,A− in order for their energy levels move towards or reach their respective target energy levels. Meanwhile the average capacitor voltages of the other valves B+,B−,C+,C− are close to their respective target voltage levels, i.e. the energy levels of the other valves B+,B−,C+,C− are close to their respective target energy levels, and so it is not necessary at this stage to transfer energy into or out of the other valves B+,B−,C+,C− in order for their energy levels to move towards or reach their respective target energy levels. The transfer energy into the pair of valves, A+,A− using the “overlap mode” is shown in FIG. 11, which shows that only the pair of valves A+,A− experience a change in energy level (as indicated by the circled area).

FIG. 12 illustrates graphically the currents flowing through the valves C+,C− in the “overlap mode” and the currents flowing through the valves A−,B+ in the “cross-overlap mode”. It can be seen from FIG. 12 that the valves C+,C− share a common current, and that valves A−,B+ share the same circulating alternating current I_{CO}, as indicated by the circled areas.

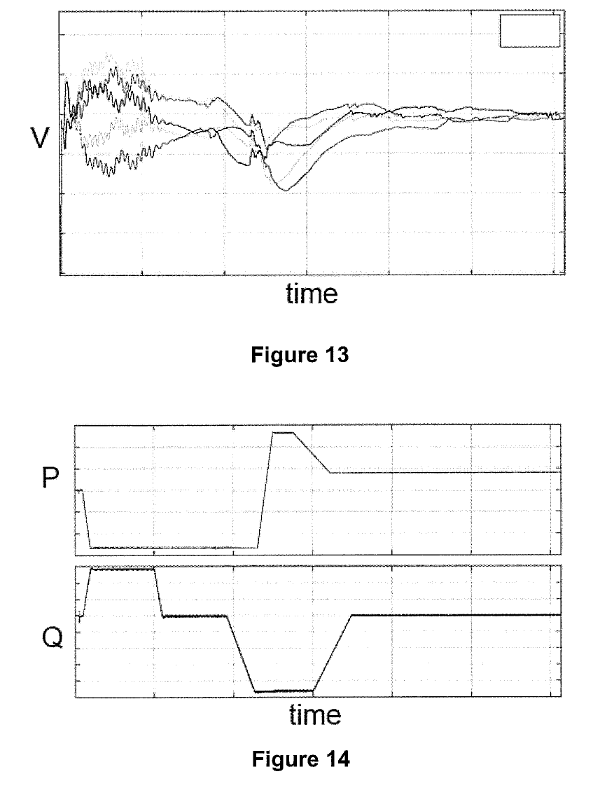

FIGS. 13 to 15 illustrate graphically the results of a simulation of the operation of the voltage source converter 30 to regulate the energy levels of the valves using the “overlap mode” and the “cross-overlap mode” using a 60 electrical degrees overlap period.

It can be seen from FIG. 13 that the average capacitor voltage of each valve 50 stays close to its target energy voltage level, i.e. the energy level of each valve 50 stays close to the respective target energy level, during the energy regulation procedure. It can be seen from FIG. 14 that the energy levels of a given valve moves towards its target energy level for different ramp values of real power (top) and reactive power (bottom).

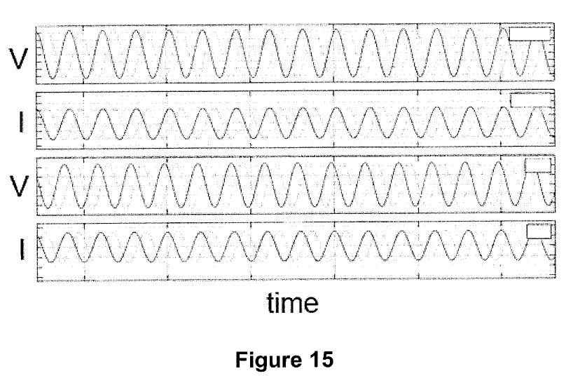

It can be seen from FIG. 15 that the total harmonic distortion (THD) of both alternating current waveforms and AC voltage waveforms at the AC terminals 42 of the voltage source converter 30 during the energy regulation procedure is less than 0.2% (measured with MATLAB/Simulink), which is below the typical 0.5% requirement imposed by utilities.

In this manner the controller 62 is programmed to control the switching of the selected valves B−,C+ to control the phase angle and amplitude of the fundamental frequency alternating current component of the circulating alternating current I_{CO} to control the amount of energy transferred to or from each selected valve B−,C+ resulting from the flow of the circulating alternating current I_{CO} through each selected valve B−,C+.

The configuration of the voltage source converter 30 of FIG. 1 therefore enables the formation of the current circulation path and the provision of the circulating alternating current I_{CO} in order for energy to be selectively transferred to and from each selected valve B−,C+ to regulate its energy level, thereby obviating the problems associated with a deviation of the energy level of at least one energy storage device from the reference value.

In comparison to the “overlap mode”, the use of the “cross-overlap mode” permits the transfer of energy to and from each selected valve B−,C+ to occur throughout the period during which the selected valve B−,C+ is connected into circuit, i.e. over a period longer than the overlap period. This increases the overall amount of time available to regulate the energy level of a given valve 50 and thereby allows the transfer of energy to and from the given valve 50 to be distributed over a longer period of time, thus reducing in less distortion of the DC and AC voltage waveforms V_{DC+},V_{DC-},V_{A′},V_{B′},V_{C′} at the DC and AC terminals 32,34,42.

In addition, in comparison to the “overlap mode”, the use of the “cross-overlap mode” also reduces the delay in regulating the energy level of each valve 50, since energy regulation can be carried out as soon as a given valve 50 is connected into circuit through the formation of the current circulation path, instead of waiting for the occurrence of the overlap period.

As indicated earlier in this specification, the valve B− of the second limb portion 40 of the second limb 36 and the valve C+ of the first limb portion 38 of the third converter limb 36 are switched into circuit between their respective DC and AC terminals 32,34,42 as part of the operation of the voltage source converter 30 to transfer power between the DC network 44 and the three-phase AC network 46, and this applies mutatis mutandis to a selected valve 50 of any one of the plurality of converter limbs 36; and another selected valve 50 of any other of the plurality of converter limbs 36, instead of just the valves B−,C+.

The controller 62 may therefore be programmed to control the switching of the valves 50 to form a plurality of current circulation paths throughout an operating cycle of the voltage source converter 30, wherein the plurality of current circulation paths respectively passes through different sets of selected valves 50. This not only permits the regulation of the energy levels of different sets of selected valves 50 during an operating cycle of the voltage source converter 30, but also lengthens the time available for regulating the energy level of a given valve 50 during an operating cycle of the voltage source converter 30. The formation of the plurality of current circulation paths may be performed such that, at any given time during the operating cycle of the voltage source converter 30, energy regulation of the energy level of at least one of the valves 50 is being carried out.

It will be understood that an increase in the energy level of a given valve is intended to include an increase in the energy level(s) of one, some or all of the capacitors of the given valve, and that a decrease in the energy level of a given valve is intended to include an decrease in the energy level(s) of one, some or all of the capacitors of the given valve.

It will be appreciated that the circulating alternating current is not necessarily restricted to the fundamental frequency alternating component, and the above principles behind the configuration of the circulating alternating current can be extended to an alternating current component of any frequency. In addition to or in place of the fundamental frequency alternating current component, the circulating alternating current may include one or more non-fundamental frequency alternating current components, such as a harmonic current component. The circulating alternating current may be configured on the basis of the superposition theorem consist of a finite or infinite series of alternating current components of different frequencies, where the phases and amplitudes of the alternating current components are chosen to regulate the energy levels of the capacitors of the selected valves.

It is envisaged that, in other embodiments of the invention, the length of the overlap period may vary. It will be appreciated that the formation of the current circulation path and the provision of the circulating alternating current does not require the presence of the overlap period of the “overlap mode”.

It is also envisaged that, in other embodiments of the invention, the director switch may be omitted from each limb portion.

It will be appreciated that the above specific embodiment of the invention is intended to be a non-limiting example of the invention, and are merely chosen to illustrate the working of the invention.

1. A voltage source converter comprising:
first and second DC terminals for connection to a DC network; and
a plurality of converter limbs, each converter limb extending between the first and second DC terminals, each converter limb including first and second limb portions separated by a respective AC terminal, the AC terminal of each converter limb for connection to a respective AC phase of a multi-phase AC network, each first limb portion extending between the corresponding first DC terminal and AC terminal, each second limb portion extending between the corresponding second DC terminal and AC terminal, each limb portion including a respective valve, each valve including at least one switching element and at least one energy storage device, the or each switching element of each valve being switchable to selectively insert the or each corresponding energy storage device into the corresponding limb portion and bypass the or each corresponding energy storage device in order to control a voltage across that valve; and
a controller programmed to control the switching of a selected valve of one of the plurality of converter limbs and another selected valve of another of the plurality of converter limbs so as to form a current circulation path passing through the selected valves, the current circulation path including: the limb portions corresponding to the selected valves, the AC phases connected to the limb portions corresponding to the selected valves; and the DC network,
wherein the controller during formation of the current circulation path switches the selected valves to force a circulating alternating current to flow through the current circulation path, the circulating alternating current including at least one alternating current component, and the controller is programmed to control the switching of the selected valves to control the phase angle and amplitude of the or each alternating current component of the circulating alternating current to control the amount of energy transferred to or from each selected valve resulting from the flow of the circulating alternating current through each selected valve.

2. The voltage source converter according to claim 1, wherein the selected valves includes: the valve of the first limb portion of one of the plurality of converter limbs; and the valve of the second limb portion of another of the plurality of converter limbs.

3. The voltage source converter according to claim 1, wherein the circulating alternating current includes a fundamental frequency alternating current component and/or at least one non-fundamental frequency alternating current component.

4. The voltage source converter according to claim 1, wherein controlling the amount of energy transferred to or from each selected valve resulting from the flow of the circulating alternating current through each selected valve includes increasing, decreasing or maintaining the energy level of each selected valve.

5. The voltage source converter according to claim 1, wherein controlling the amount of energy transferred to or from each selected valve resulting from the flow of the circulating alternating current through each selected valve includes controlling the energy level of each selected valve to move towards or reach a target energy level.

6. A voltage source converter according to claim 1, wherein the controller is programmed to control the switching of the selected valves to shift the phase angle of and/or vary the amplitude of the or each alternating current component to modify the amount of energy transferred to or from each selected valve resulting from the flow of the circulating alternating current through each selected valve.

7. A voltage source converter according to claim 1, wherein the controller is programmed to control the switching of the valves to form a plurality of current circulation paths throughout an operating cycle of the voltage source converter, wherein the plurality of current circulation paths passes through different sets of selected valves respectively.

8. A voltage source converter according to claim 1, wherein the controller is programmed to control the switching of the valves during the formation of the current circulation path to selectively insert the or each corresponding energy storage device into the corresponding limb portion and bypass the or each corresponding energy storage device so as to control the configuration of an AC voltage waveform at the corresponding AC terminal to facilitate the transfer of power between the DC and AC networks.

9. A voltage source converter according to claim 1, wherein each valve includes a plurality of modules, each module including at least one switching element and at least one energy storage device, the or switching element and the or each energy storage device in each module being arranged to be combinable to selectively provide a voltage source.

10. A voltage source converter according to claim 1, wherein each limb portion includes a director switch connected in series with the corresponding valve between the respective DC and AC terminals, and the director switches of the first and second limb portions are switchable to switch the respective limb portions into and out of circuit between the respective DC and AC terminals.

11. A method of operating a voltage source converter, the voltage source converter comprising:
first and second DC terminals for connection to a DC network; and
a plurality of converter limbs, each converter limb extending between the first and second DC terminals, each converter limb including first and second limb portions separated by a respective AC terminal, the AC terminal of each converter limb for connection to a respective AC phase of a multi-phase AC network, each first limb portion extending between the corresponding first DC terminal and AC terminal, each second limb portion extending between the corresponding second DC terminal and AC terminal, each limb portion including a respective valve, each valve including at least one switching element and at least one energy storage device, the or each switching element of each valve being switchable to selectively insert the or each corresponding energy storage device into the corresponding limb portion and bypass the or each corresponding energy storage device in order to control a voltage across that valve,
wherein the method comprises the steps of:
switching a selected valve of one of the plurality of converter limbs and another selected valve of another of the plurality of converter limbs so as to form a current circulation path passing through the selected valves, the current circulation path including: the limb portions corresponding to the selected valves, the AC phases connected to the limb portions corresponding to the selected valves; and the DC network; and
during formation of the current circulation path, switching the selected valves to force a circulating alternating current to flow through the current circulation path, the circulating alternating current including at least one alternating current component; and
switching the selected valves to control the phase angle and amplitude of the or each alternating current component of the circulating alternating current to control the amount of energy transferred to or from each selected valve resulting from the flow of the circulating alternating current through each selected valve.
